(19) United States
(12) Patent Application Publication
(10) Pub. No.: US 2026/0156697 A1
(43) Pub. Date: Jun. 4, 2026

(54) COMMUNICATION DEVICE, CONTROL METHOD OF THE SAME, AND STORAGE MEDIUM

(71) Applicant: CANON KABUSHIKI KAISHA, Tokyo (JP)

(72) Inventor: YUICHI YAGI, Tokyo (JP)

(21) Appl. No.: 19/396,595

(22) Filed: Nov. 21, 2025

(30) Foreign Application Priority Data
Nov. 29, 2024 (JP) 2024-208885

(51) Int. Cl. H04W 76/14; H04W 8/22; H04W 12/0431

(52) U.S. Cl. CPC H04W 76/14; H04W 8/22; H04W 12/0431

(57) ABSTRACT

A communication device capable of communicating with an information processing device is provided. The communication device accepts an operation for applying any of a plurality of settings including a first setting and a second setting to the communication device, as a setting regarding security of the communication device, executes communication based on Wi-Fi Direct R1 between the information processing device and the communication device, executes communication based on Wi-Fi Direct R2 between the information processing device and the communication device, and controls, based on the first setting being applied to the communication device as the setting regarding security of the communication device, the communication device such that communication based on Wi-Fi Direct R1 is not executable between the information processing device and the communication device.

### BACKGROUND

### Field of the Technology

The technology according to the present disclosure relates to a communication device, a control method of the same, and a storage medium.

### Description of the Related Art

In recent years, the development of communication technologies such as wireless local area networks (LANs) is progressing with an increase in the amount of data communicated. The Institute of Electrical and Electronic Engineers (IEEE) 802.11 standard series is known as a major communication standard for wireless LANs. The IEEE 802.11 standard series includes IEEE 802.11a/b/g/n/ac/ax standards, for example. For example, the latest standard IEEE 802.11ax standardizes technologies for using orthogonal frequency division multiple access (OFDMA) to achieve a high peak throughput up to 9.6 gigabits per second (Gbps) and increase communication speeds under crowded conditions. OFDMA is an abbreviation for Orthogonal Frequency-Division Multiple Access.

On the other hand, the Wi-Fi Alliance has developed programs to authenticate wireless LAN devices. For example, the WFD standard has been developed to define a procedure for exchanging communication parameters between wireless LAN stations (STAs) and establishing a communication link between the STAs without using an access point (AP). WFD is an abbreviation for Wi-Fi Direct (registered trademark).

Also, the Wi-Fi Aware standard, which is a standard for searching for a service provided by a device, has been developed. For example, Japanese Patent Laid-Open No. 2019-201427 describes detecting a communication terminal using rules specified in the Wi-Fi Aware standard.

Communication devices may have a function of establishing a communication link in accordance with the Wi-Fi Direct (WFD) standard. For example, communication devices detect the presence of each other as a communication partner in accordance with a detection procedure specified in the WFD standard, and execute a connection procedure with the detected communication device. For example, a communication device detects the presence of another communication device by using a detection method in which a Probe Request frame is used. This detection method is used in a communication standard or connection method called WFD R1. On the other hand, the communication device may detect the presence of another communication device by using a detection method in which a Service Discovery frame is used. This detection method is used in a communication standard or connection method called WFD R2. Security protocols that are used in WFD connection procedures include Wi-Fi Protected Access (WPA), WPA2, and WPA3. Parameters are exchanged in the connection procedure and a security protocol to be used is determined.

In WFD R1, communication devices only need to support WPA2 as the security protocol, and support for the more secure WPA3 is not required. Accordingly, communication using WPA3 is not always possible with a communication partner that is connected using WFD R1. On the other hand, support for WPA3 is required in WFD R2. As described above, security protocols that can be used may differ depending on the connection method. Therefore, a communication device needs to determine a connection method in which an appropriate security protocol can be used in accordance with security settings.

### SUMMARY

The technology according to the present disclosure provides a mechanism for setting a wireless direct connection method in accordance with security settings.

According to one aspect of the present disclosure, there is provided a communication device capable of communicating with an information processing device, the communication device comprising: at least one memory storing instructions; and at least one processor that is in communication with the at least one memory and that, when executing the instructions, cooperates with the at least one memory to execute processing, the processing including: accepting an operation for applying any of a plurality of settings including a first setting and a second setting to the communication device, as a setting regarding security of the communication device; executing communication based on Wi-Fi Direct R1 between the information processing device and the communication device; executing communication based on Wi-Fi Direct R2 between the information processing device and the communication device; and controlling, based on the first setting being applied to the communication device as the setting regarding security of the communication device, the communication device such that communication based on Wi-Fi Direct R1 is not executable between the information processing device and the communication device.

With the above configuration, it is possible to set a wireless direct connection method in accordance with security settings of a communication device.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a system configuration example.

FIGS. 2A and 2B are diagrams showing a configuration example of an MFP.

FIGS. 3A to 3C are diagrams showing examples of display in an operation display unit of the MFP.

FIGS. 4A and 4B are diagrams showing a configuration of a portable terminal device.

FIG. 5 is a diagram showing a configuration of an access point.

FIG. 6 is a sequence diagram showing connection processing of a conventional WFD standard.

FIG. 7 is a sequence diagram showing connection processing of a new WFD standard.

FIGS. 8A to 8D are diagrams showing examples of security setting screens displayed in the operation display unit of the MFP.

FIGS. 9A to 9C are diagrams showing examples of wireless direct setting screens displayed in the operation display unit of the MFP.

FIGS. 10A to 10F are diagrams showing examples of mobile portal screens displayed in the operation display unit of the MFP.

FIGS. 11A to 11C are flowcharts for setting a WFD operation version.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

It should be noted that the present embodiment is merely an example, and specific examples of components, processing steps, display screens, and the like are not intended to limit the scope of the present disclosure thereto unless otherwise stated.

### System Configuration

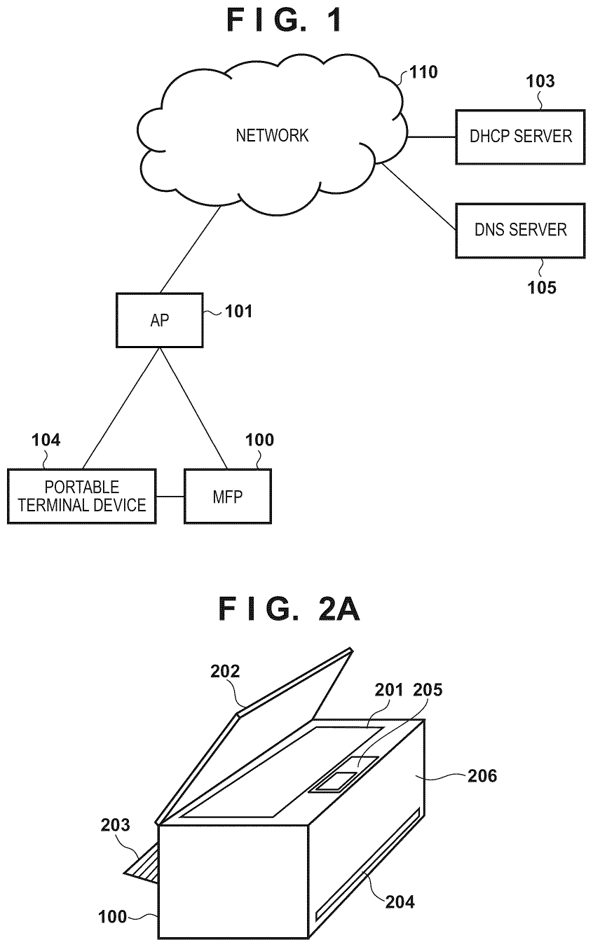

FIG. 1 shows a configuration example of a system according to the present embodiment. This system is a wireless communication system in which a plurality of communication devices can perform wireless communication with each other, for example. In the example shown in FIG. 1, the system includes a portable terminal device 104 and an MFP 100 as communication devices, an AP 101, which is an access point, a DHCP server 103, and a network 110. The portable terminal device 104 has a wireless communication function using a wireless LAN or the like. In the following description, a wireless LAN may be referred to as “WLAN”. The portable terminal device 104 may be a personal information terminal such as a personal digital assistant (PDA), a mobile phone (smartphone), a digital camera, a personal computer, or the like.

The MFP 100 is a printing device that has a printing function and may further have a reading (scanner) function, a FAX function, and a telephone function. Also, the MFP 100 of the present embodiment has a communication function that enables wireless communication with the portable terminal device 104. In the present embodiment, a case where the MFP 100 is used is described as an example, but there is no limitation to this example. For example, instead of the MFP 100, it is also possible to use a scanner, a projector, a portable terminal, a smartphone, a notebook PC, a tablet terminal, a PDA, a digital camera, a music reproduction device, a television, a smart speaker, or the like having a communication function. Note that MFP is an acronym of Multi Function Peripheral.

The AP 101 is provided separately from (outside) the portable terminal device 104 and the MFP 100 and operates as a base station device of the WLAN. A communication device having a WLAN communication function can perform communication via the AP 101 in an infrastructure mode of the WLAN. In the following description, an access point may be referred to as an “AP”. Also, the infrastructure mode may be referred to as a “wireless infrastructure mode”. The AP 101 performs wireless communication with a (authenticated) communication device for which connection to the AP 101 has been permitted, and relays wireless communication between the communication device and another communication device. Also, the AP 101 is connected to a wired communication network, for example, and may relay communication between a communication device connected to the wired communication network and another communication device that has established a wireless connection to the AP 101.

The DHCP server 103 is connected to the MFP 100 via the AP 101 and the network 110 and provides a service to the MFP 100 in response to a request from the MFP 100. Note that, in FIG. 1, the DHCP server 103 is connected as a device different from the AP 101, but a configuration is also possible in which the AP 101 has a DHCP server function. A DNS server 105 is connected to the MFP 100 and the portable terminal device 104 via the AP 101 and the network 110 and provides a service for name resolution in response to a request from the MFP 100 or the portable terminal device 104. Here, the network 110 may be the Internet, a closed network of a company, or a mobile phone network.

### External Appearance Configuration of MFP

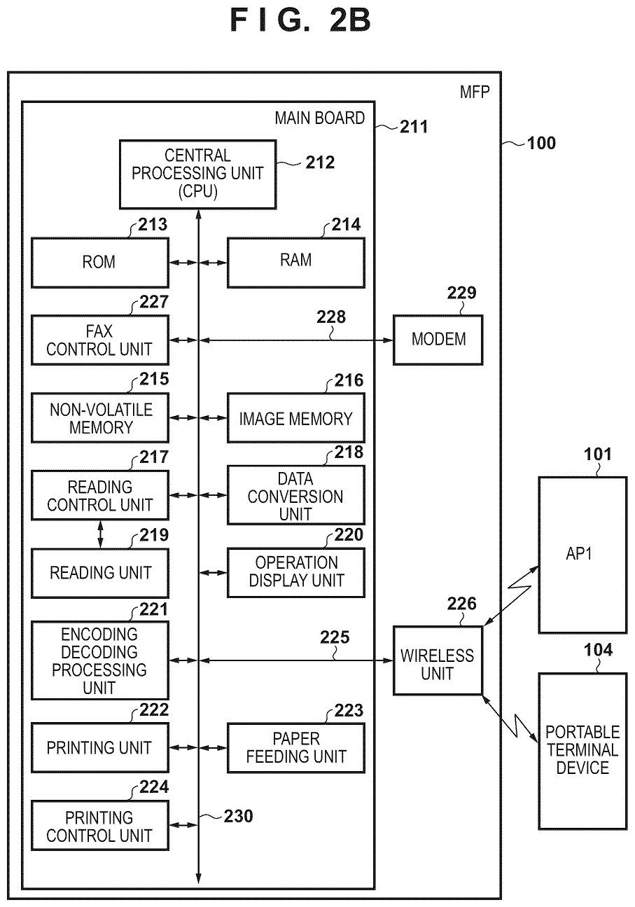

FIG. 2A shows an example of an external appearance configuration of the MFP 100. The MFP 100 includes a document table 201, a document cover 202, a printing paper inlet 203, a printing paper outlet 204, and an operation display unit 205, for example. The document table 201 is a table on which a document that is to be read is placed. The document cover 202 is a cover for pressing the document placed on the document table 201 and preventing light emitted from a light source toward the document for scanning from leaking to the outside. The printing paper inlet 203 is an inlet to which sheets of paper having various sizes can be set. The printing paper outlet 204 is an outlet from which printed sheets are discharged. Sheets of paper set on the printing paper inlet 203 are conveyed to a printing unit one by one, subjected to printing in the printing unit, and then discharged from the printing paper outlet 204. The operation display unit 205 includes keys such as letter input keys, cursor keys, an enter key, and a cancel key, LEDs, an LCD, etc., and is configured to be capable of accepting operations made by a user to activate various functions of the MFP and set various settings. The operation display unit 205 may also include a touch panel display. The MFP 100 has a wireless communication function for communicating via the WLAN and includes a wireless communication antenna 206 to be used for the wireless communication, although the antenna does not necessarily have to be visible from the outside. Similarly to the portable terminal device 104, the MFP 100 can perform wireless communication via the WLAN in the 2.4 GHz, 5 GHz, and 6 GHz bands.

### Configuration of MFP

FIG. 2B shows an example configuration of the MFP 100. The MFP 100 includes a main board 211 that performs main control of the MFP 100 and a wireless unit 226 that is a communication module that performs WLAN communication with use of at least one common antenna. Also, the MFP 100 includes a modem 229 for wired communication, for example. The main board 211 includes a central processing unit (CPU) 212, a ROM 213, a RAM 214, a non-volatile memory 215, an image memory 216, a reading control unit 217, a data conversion unit 218, a reading unit 219, and an encoding decoding processing unit 221, for example. The main board 211 also includes a printing unit 222, a paper feeding unit 223, a printing control unit 224, and an operation display unit 220, for example. These functional units included in the main board 211 are connected to each other via a system bus 230 controlled by the CPU 212. Also, the main board 211 and the wireless unit 226 are connected via a dedicated bus 225, and the main board 211 and the modem 229 are connected via a bus 228, for example.

The CPU 212 is a system control unit including at least one processor and controls the entire MFP 100. Processing performed by the MFP 100 described below is realized by the CPU 212 by executing a program stored in the ROM 213, for example. Note that dedicated hardware may also be prepared for each process. Control programs executed by the CPU 212, an embedded OS program, and the like are stored in the ROM 213. In the present embodiment, the CPU 212 performs software control such as scheduling and task switching by executing each control program stored in the ROM 213 under management of the embedded OS, which is also stored in the ROM 213.

The RAM 214 is constituted by an SRAM, for example. Data such as program control variables, setting values registered by the user, and data such as management data of the MFP 100 are stored in the RAM 214. The RAM 214 may also be used as a buffer for various operations. The non-volatile memory 215 is constituted by a memory such as a flash memory, for example, and keeps data stored therein even when the power source of the MFP 100 is turned off. The image memory 216 is constituted by a memory such as a DRAM. Image data received via the wireless unit 226, image data processed by the encoding decoding processing unit 221, and the like are accumulated in the image memory 216. Note that the memory configuration of the MFP 100 is not limited to the above configuration. The data conversion unit 218 analyzes data in various forms and converts image data to print data, for example.

The reading control unit 217 controls the reading unit 219 (e.g., a contact image sensor (CIS)) to optically read a document placed on the document table 201. The reading control unit 217 converts an image obtained by optically reading the document to electrical image data (image signal) and outputs the image data. At this time, the reading control unit 217 may output the image data after performing various types of image processing such as binarization processing or halftone processing.

The operation display unit 220 is the operation display unit 205 described with reference to FIG. 2A, executes display on a display under display control performed by the CPU 212, and generates signals in response to a user operation, for example.

The encoding decoding processing unit 221 performs encoding processing, decoding processing, and scaling processing on image data (JPEG, PNG, etc.) handled by the MFP 100.

The paper feeding unit 223 holds sheets of paper to be used for printing. The paper feeding unit 223 can supply the sheets of paper that have been set, under control performed by the printing control unit 224. The paper feeding unit 223 may include a plurality of paper feeding units to hold multiple types of sheets in the single device, and from which of the paper feeding units sheets are supplied can be controlled by the printing control unit 224.

The printing control unit 224 performs various types of image processing such as smoothing processing, printing density correction processing, and color correction on image data to be printed, and outputs processed image data to the printing unit 222. The printing unit 222 is configured to be capable of executing ink jet printing processing, for example, and causes a print head to eject ink supplied from an ink tank to record an image on a recording medium such as paper. Note that the printing unit 222 may also be configured to be capable of executing other printing processing such as electrophotographic printing processing. Also, the printing control unit 224 may periodically read information regarding the printing unit 222 and update status information including an ink level in the ink tank, the state of the print head, and the like stored in the RAM 214, for example.

The wireless unit 226 can provide the WLAN communication function, e.g., a function similar to a function realized by a WLAN unit 401 of the portable terminal device 104, for example. That is to say, the wireless unit 226 converts data to a packet in accordance with WLAN standards and transmits the packet to another device, and also restores original data from a packet received from an external device and outputs the data to the CPU 212. The wireless unit 226 can perform communication as a station in accordance with the IEEE 802.11 standard series. In particular, the wireless unit 226 can perform communication as a station in accordance with IEEE 802.11a/b/g/n/ac/ax. In the following description, a station may be referred to as a “STA”.

The wireless unit 226 supports IEEE 802.11ax, i.e., Wi-Fi 6 (trademark) and can perform processing in accordance with IEEE 802.11ax. That is to say, the MFP 100 can perform processing as a STA that supports (complies with) OFDMA and/or operations (processing) as a STA that supports (complies with) TWT. OFDMA is an abbreviation for Orthogonal Frequency-Division Multiple Access. TWT is an abbreviation for Target Wake Time. The MFP 100 supports TWT, and accordingly, timings of data communication from a master device to the STA are adjusted. The wireless unit 226 (MFP 100), which is the STA, causes the communication function to transition to a sleep state when it is not necessary to wait for a signal to be received. This reduces power consumption. The wireless unit 226 also supports Wi-Fi 6E (trademark). That is to say, the wireless unit 226 can perform communication in the 6 GHz band (5.925 GHz to 7.125 GHz) as well. The 6 GHz band does not include a range in which dynamic frequency selection (DFS) is performed, as in the 5 GHz band. Accordingly, communication disconnection due to standby time for DFS does not occur in communication performed in the 6 GHz band, and better communication can be expected. In this embodiment, processing in accordance with IEEE 802.11ax is performed, but the portable terminal device 104 and the MFP 100 may operate in accordance with other standards of the IEEE 802.11 series. For example, the portable terminal device 104 and the MFP 100 may operate in accordance with IEEE 802.11be or succeeding standards.

Note that the portable terminal device 104 and the MFP 100 can perform P2P (WLAN) communication based on WFD, and the wireless unit 226 has a software access point (soft AP) function or a group owner function. That is to say, the wireless unit 226 can establish a network for the P2P communication and determine a channel to be used for the P2P communication. WFD referred to here is based on standards set by the Wi-Fi Alliance. The wireless unit 226 can also operate as a client of WFD.

### Operation Display Unit of MFP

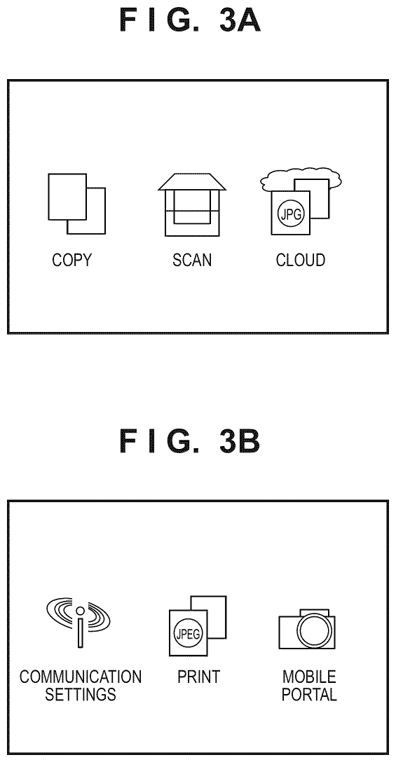

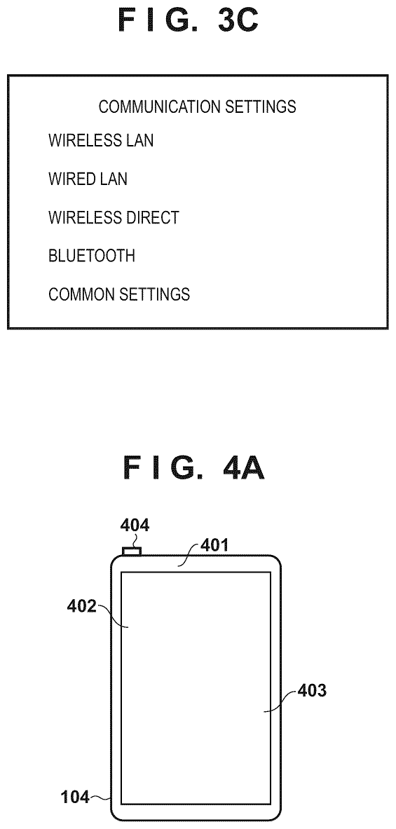

FIGS. 3A to 3C schematically show an example of screens displayed on a display (touch panel display) included in the operation display unit 220 of the MFP 100. FIG. 3A shows an example of a home screen, which is displayed in a state (idling state or standby state) in which the power source of the MFP 100 has been turned on and operations such as printing and scanning are not performed. Display items (menu items) respectively corresponding to copy, scan, and cloud are displayed in FIG. 3A. The cloud is a menu item relating to a cloud function provided using Internet communication. When any of the menu items is selected through an operation made on a key or the touch panel, the MFP 100 can start to execute the corresponding setting or function. Upon accepting an operation made on a key or the touch panel via the home screen shown in FIG. 3A, the MFP 100 can seamlessly display a screen different from the screen shown in FIG. 3A.

FIG. 3B shows a display example of another portion of the home screen. The home screen transitions from the state shown in FIG. 3A to the screen shown in FIG. 3B in response to an operation (e.g., a slide operation to the left or the right) for displaying another page of the home screen. Display items (menu items) respectively corresponding to communication settings, printing, and a mobile portal are displayed in FIG. 3B. When any of these menu items is selected, a function corresponding to the selected menu item, i.e., a printing function, a mobile portal function, or communication setting is executed.

FIG. 3C shows an example of a menu screen of communication settings, which is displayed when “communication settings” is selected on the screen shown in FIG. 3B. On the menu screen of communication settings, “wireless LAN”, “wired LAN”, “wireless direct”, “Bluetooth”, and “common settings” are displayed as menu items (options). The “wireless LAN”, “wired LAN”, and “wireless direct” are menu items relating to LAN settings and can be used to set wired connection, make the wireless infrastructure mode enabled or disabled, or make a P2P mode such as a WFD mode or a soft AP mode enabled or disabled. When the item “wireless LAN” is selected through a user operation to make the wireless LAN enabled, the wireless infrastructure mode becomes enabled. When the item “wireless direct” is selected through a user operation to make wireless direct enabled, the P2P (WLAN) mode becomes enabled. Also, a common setting menu relating to each connection type is displayed on this screen. Furthermore, the user can set a frequency band and a frequency channel of the wireless LAN via this screen.

### External Appearance Configuration of Portable Terminal Device

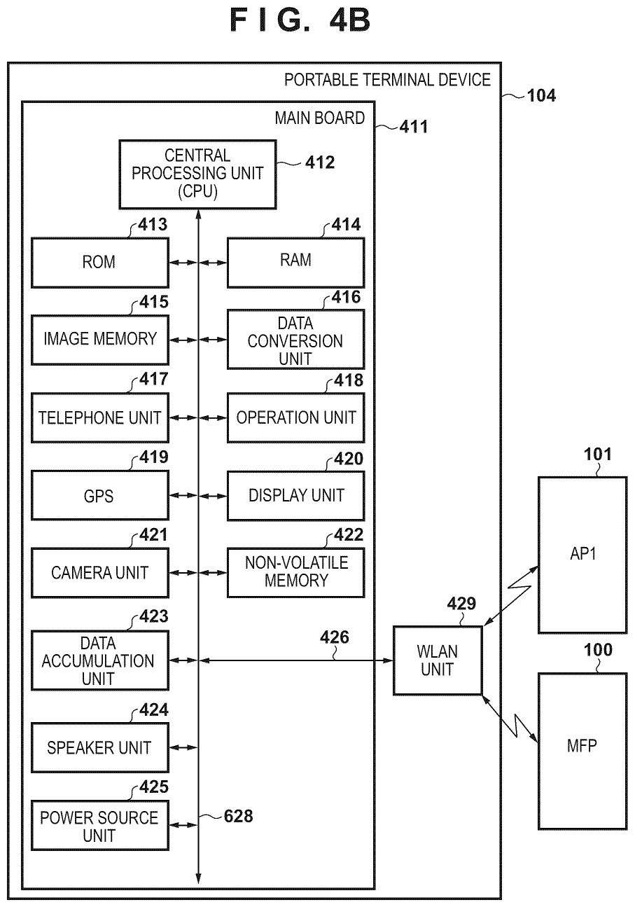

FIG. 4A is a diagram showing an example of an external appearance configuration of the portable terminal device 104. In the present embodiment, a case where the portable terminal device 104 is a common smartphone is shown as an example. The portable terminal device 104 includes a display unit 402, an operation unit 403, and a power source key 404, for example. The display unit 402 is a display including a display mechanism of liquid crystal display (LCD), for example. Note that the display unit 402 may also use, for example, light emitting diodes (LEDs) to display information. The portable terminal device 104 may also have a function of outputting information by using audio in addition to or instead of the display unit 402. The operation unit 403 includes a hardware key such as a key or a button, a touch panel, and the like for detecting user operations. Note that, in this example, a common touch panel display is used by the display unit 402 to display information and by the operation unit 403 to accept user operations, and accordingly, the display unit 402 and the operation unit 403 are realized by a single device. In this case, button icons and a software keyboard are displayed using a display function of the display unit 402, and a touch made by the user on any of the displayed items is detected by an operation accepting function of the operation unit 403, for example. Note that a configuration is also possible in which the display unit 402 and the operation unit 403 are separate from each other, and hardware used for display and hardware used for accepting operations may be prepared separately. The power source key 404 is a hardware key for accepting a user operation for turning on or off the power source of the portable terminal device 104.

The portable terminal device 104 includes the WLAN unit 401 that provides the WLAN communication function, although the WLAN unit does not necessarily have to be visible from the outside. The WLAN unit 401 is configured to be capable of executing data (packet) communication in a WLAN system that complies with the IEEE 802.11 standard series (e.g., IEEE 802.11a/b/g/n/ac/ax), for example. Also, the WLAN unit 401 can perform communication as an AP that supports Wi-Fi Agile Multiband (trademark). However, there is no limitation to this configuration, and the WLAN unit 401 may also be capable of executing communication in a WLAN system that complies with another standard. In this example, the WLAN unit 401 can perform communication in the 2.4 GHz, 5 GHZ, and 6 GHz bands. Also, the WLAN unit 401 can perform communication based on WFD, communication in the soft AP mode, and communication in the wireless infrastructure mode, for example. Operations in these modes will be described later.

### Configuration of Portable Terminal Device

FIG. 4B shows an example configuration of the portable terminal device 104. In an example, the portable terminal device 104 includes a main board 411 that performs main control of the portable terminal device 104 and a WLAN unit 429 that performs WLAN communication. The main board 411 includes a CPU 412, a ROM 413, a RAM 414, an image memory 415, a data conversion unit 416, a telephone unit 417, a GPS 419, a camera unit 421, a non-volatile memory 422, a data accumulation unit 423, a speaker unit 424, and a power source unit 425, for example. Here, CPU is an acronym of Central Processing Unit, ROM is an acronym of Read Only Memory, RAM is an acronym of Random Access Memory, and GPS is an acronym of Global Positioning System. Also, the portable terminal device 104 includes a display unit 420 and an operation unit 418. These functional units included in the main board 411 are connected to each other via a system bus 628 controlled by the CPU 412. Also, the main board 411 and the WLAN unit 429 (the WLAN unit 401 described above) are connected via a dedicated bus 426, for example.

The CPU 412 is a system control unit including at least one processor and controls the entire portable terminal device 104. Processing performed by the portable terminal device 104 described below is realized by the CPU 412 by executing a program stored in the ROM 413, for example. Note that dedicated hardware may also be prepared for each process. Control programs executed by the CPU 412, an embedded operating system (OS) program, and the like are stored in the ROM 413. In the present embodiment, the CPU 412 performs software control such as scheduling and task switching by executing each control program stored in the ROM 413 under management of the embedded OS, which is also stored in the ROM 413.

The RAM 414 is constituted by a static RAM (SRAM), for example. Data such as program control variables, setting values registered by the user, and data such as management data of the portable terminal device 104 are stored in the RAM 414. The RAM 414 may also be used as a buffer for various operations. The image memory 415 is constituted by a memory such as a dynamic RAM (DRAM). Image data received via the WLAN unit 429 and image data read out from the data accumulation unit 423 are temporarily stored in the image memory 415 to be processed by the CPU 412. The non-volatile memory 422 is constituted by a memory such as a flash memory, for example, and keeps data stored therein even when the power source of the portable terminal device 104 is turned off. Note that the memory configuration of the portable terminal device 104 is not limited to the above configuration. For example, the image memory 415 and the RAM 414 may be configured as a common memory, and the data accumulation unit 423 may be used for data backup or the like. Also, DRAM is described as an example of the image memory 415 in the present embodiment, but another storage medium such as a hard disk or a non-volatile memory may also be used as the image memory 415.

The data conversion unit 416 analyzes data in various forms and performs data conversion such as color conversion and image conversion. The telephone unit 417 realizes telephone communication by controlling a telephone line and processing audio data that is input or output via the speaker unit 424. The GPS 419 obtains positional information such as the current latitude and longitude of the portable terminal device 104 by receiving radio waves transmitted from satellites.

The camera unit 421 has a function of electronically recording and encoding an image input through a lens. Image data obtained by the camera unit 421 by capturing an image is stored in the data accumulation unit 423. The speaker unit 424 performs control to realize a function of inputting or outputting audio for the telephone function and an alarm function, for example. The power source unit 425 is a portable battery, for example, and performs control to supply power to the portable terminal device. Examples of power source states include a battery run-down state in which the battery level is 0, a power off state in which the power source key 404 has not been pressed, a booted state in which the portable terminal device has been normally booted, and a power saving state in which the portable terminal device has been booted but power consumption is reduced.

The display unit 420 is the display unit 402 described with reference to FIG. 4A, accepts various input operations, and displays operating conditions and status conditions of the MFP 100 under control performed by the CPU 412. The operation unit 418 is the operation unit 403 described with reference to FIG. 4A and, upon accepting a user operation, executes control for generating an electrical signal corresponding to the operation and outputting the signal to the CPU 412, for example.

The portable terminal device 104 performs data communication with another device such as the MFP 100 by performing wireless communication with use of the WLAN unit 429. The WLAN unit 429 converts data to a packet and transmits the packet to another device. Also, the WLAN unit 429 restores original data from a packet received from an external device and outputs the data to the CPU 412. The WLAN unit 429 is a unit for realizing communication in accordance with WLAN standards. The WLAN unit 429 can operate in parallel in at least two communication modes including the wireless infrastructure mode and the P2P (WLAN) mode. Note that frequency bands used in these communication modes may be limited due to the functions and performance of hardware.

### Configuration of Access Point

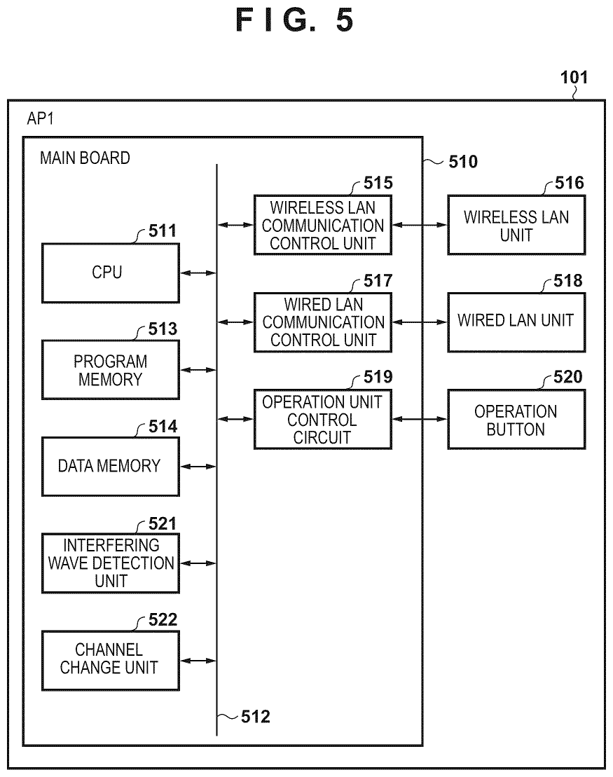

FIG. 5 is a block diagram showing a configuration of the AP 101 that has a wireless LAN access point function. The AP 101 includes a main board 510 that controls the AP 101, a wireless LAN unit 516, a wired LAN unit 518, and an operation button 520.

A CPU 511, which is a microprocessor included in the main board 510, operates in accordance with a control program stored in a program memory 513, which is a ROM connected to the CPU 511 via an internal bus 512, and contents in a data memory 514, which is a RAM. The CPU 511 controls the wireless LAN unit 516 via a wireless LAN communication control unit 515 to perform wireless LAN communication with another communication terminal device. Also, the CPU 511 controls the wired LAN unit 518 via a wired LAN communication control unit 517 to perform wired LAN communication with another communication terminal device. The CPU 511 can accept an operation made on the operation button 520 by a user by controlling an operation unit control circuit 519. The CPU 511 includes at least one processor.

The AP 101 also includes an interfering wave detection unit 521 and a channel change unit 522. The interfering wave detection unit 521 performs processing for detecting an interfering wave while wireless communication is performed in a range in which dynamic frequency selection (DFS) is performed. If an interfering wave is detected while wireless communication is performed in a range in which DFS is performed, the channel change unit 522 performs processing for changing the current channel to a channel that is used when it is necessary to immediately change the used channel to an available channel, for example.

### P2P Communication Method

Next, the following describes an outline of a P2P (WLAN) communication method in which devices directly perform wireless communication with each other without using an external access point in WLAN communication. The P2P (WLAN) communication can be realized with use of a plurality of methods. For example, a communication device can support a plurality of modes for the P2P (WLAN) communication and execute the P2P (WLAN) communication by selectively using any of the plurality of modes.

The following two modes are conceivable as P2P modes.
Soft AP mode
Wi-Fi Direct (WFD) mode

A communication device that can execute the P2P communication may be configured to support at least one of these modes. On the other hand, even a communication device that can execute the P2P communication does not necessarily have to support all of these modes and may be configured to support only some of these modes.

In a communication device (e.g., the portable terminal device 104) having a communication function based on WFD, an application for realizing the communication function (which may be a dedicated application) is called in response to an operation unit of the communication device accepting a user operation. Then, the communication device may display a screen including a user interface (UI) provided by the application to prompt a user operation and execute WFD communication based on the user operation.

### Soft AP Mode

In the soft AP mode, a communication device (e.g., the portable terminal device 104) operates as a client that requests various services. Another communication device (e.g., the MFP 100) operates as a soft AP that can execute functions of an AP in the WLAN in accordance with a setting set by software. Note that it is sufficient to use commands and parameters defined in Wi-Fi (registered trademark) standards, as commands and parameters transmitted to establish a wireless connection between the client and the soft AP, and accordingly, descriptions thereof are omitted. Also, the MFP 100 operating in the soft AP mode determines, as a master station, a frequency band and a frequency channel. Therefore, the MFP 100 can select a frequency band to be used from the 2.4 GHz band, the 5 GHz band, and the 6 GHz band, and a frequency channel to be used in the selected frequency band. In the soft AP mode, a negotiation for determining the roles is not performed and the communication devices need not comply with the WFD standard set by the Wi-Fi Alliance.

### WFD Mode

The MFP 100 may be booted always as a master station (autonomous group owner) in the WFD mode. In this case, there is no need to perform GO Negotiation processing for determining roles. Also, in this case, the MFP 100 determines, as the master station, a frequency band and a frequency channel. Therefore, the MFP 100 can select a frequency band to be used from the 2.4 GHz band, the 5 GHz band, and the 6 GHz band, and a frequency channel to be used in the selected frequency band. In the WFD mode, a configuration may be adopted in which a negotiation (GO Negotiation) is performed to determine which device operates as a group owner and which device operates as a client.

### Wireless Infrastructure Mode

In the wireless infrastructure mode, communication devices (e.g., the portable terminal device 104 and the MFP 100) that perform communication with each other are connected to an external AP (e.g., the AP 101) that supervises a network, and communication between the communication devices is performed via the AP. In other words, communication between the communication devices is executed via a network established by the external AP. The portable terminal device 104 and the MFP 100 each find the AP 101 and transmit a connection request to the AP 101 to be connected to the AP 101, and thus communication between these communication devices can be performed via the AP 101 in the wireless infrastructure mode. Note that the plurality of communication devices may also be connected to different APs. In this case, communication between the communication devices can be performed through data transfer between the APs. It is sufficient to use commands and parameters defined in the Wi-Fi standards, as commands and parameters transmitted to perform communication between the communication devices via the access point, and accordingly, descriptions thereof are omitted. Also, in this case, the AP 101 determines a frequency band and a frequency channel. Therefore, the AP 101 can select a frequency band to be used from the 2.4 GHz band, the 5 GHz band, and the 6 GHz band, and a frequency channel to be used in the selected frequency band.

It is assumed that WFD includes a method based on a conventional standard and a method based on a new standard. In other words, it is assumed that the WFD standard includes a plurality of methods based on standards of different versions. A conventional method of WFD will be referred to as “WFD R1”, and a new method of WFD will be referred to as “WFD R2”. WFD R1 and WFD R2 differ in device search and parameter exchange methods.

### Connection Processing of Conventional WFD Standard

The portable terminal device 104 and the MFP 100 support a function that is made open to the public as Wi-Fi Direct. Wi-Fi Direct is a function that enables a device supporting Wi-Fi Direct to establish its own Wi-Fi network without the need for an Internet connection. Specifically, devices supporting Wi-Fi Direct, such as the portable terminal device 104 and the MFP 100, can be directly connected to each other even in an environment in which the AP 101 or the like is absent.

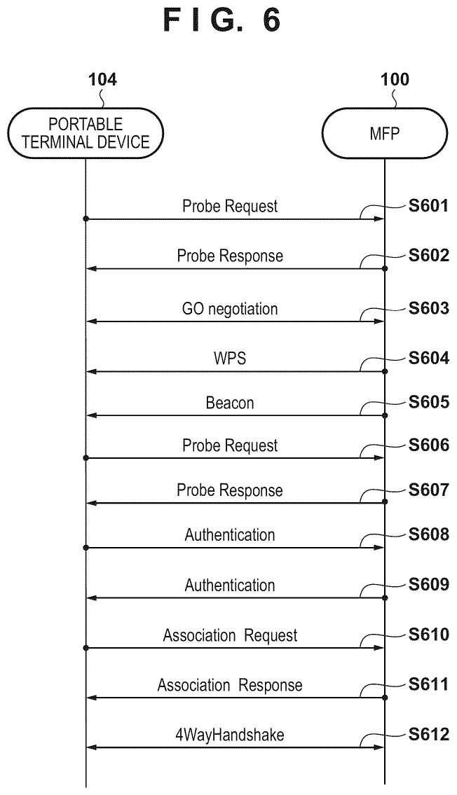

FIG. 6 is a sequence diagram of processing for connecting the portable terminal device 104 and the MFP 100 in accordance with the WFD standard. The sequence shown here is a processing sequence of WFD R1. Processing executed by the devices in this sequence is realized by the CPU included in each of the devices by loading various programs stored in a memory such as the ROM included in the device into the RAM included in the device and executing the programs.

The processing in this sequence starts, for example, in response to an instruction to start WFD being received from a user by the portable terminal device 104 and the MFP 100. Upon accepting an operation for starting WFD from the user, the portable terminal device 104 and the MFP 100 search for a partner device by repeating a Listen state and a Search state. There may be a period for scanning each channel before these states. In the Listen state, the portable terminal device 104 and the MFP 100 select 1ch in the 2.4 GHz band, for example, and wait for a Probe Request frame from other communication devices. In the Search state, the portable terminal device 104 and the MFP 100 transmit a Probe Request frame while switching frequency channels (e.g., 1ch, 6ch, and 11ch) and wait for a Probe Response frame.

In step S601, the portable terminal device 104 transmits a Probe Request frame to search for a communication device supporting WFD. The Probe Request frame is transmitted to search for a partner device that is the target of the search. Here, the communication device performing the search is the portable terminal device 104 and the partner device as the target of the search is the MFP 100. The Probe Request frame has a WFD attribute (P2P IE), specifying that the target of the search is a communication device supporting WFD.

Upon receiving the Probe Request frame, the MFP 100 transmits a Probe Response frame in step S602. The portable terminal device 104 receives the Probe Response frame transmitted by the MFP 100 and thus detects the MFP 100 as the communication partner of WFD. Note that the Probe Request frame and the Probe Response frame include P2P IE and may include a Multi-Link element. The Multi-Link element may include communication parameters used for multi-link communication defined by the IEEE 802.11be standard. This makes it possible to set a plurality of links between the communication devices in one connection procedure. In this way, in WFD R1, it is possible to detect the presence of another communication device through first search processing using the Probe Request/Response frames. The first search processing described above is a search sequence of WFD R1.

In step S603, the portable terminal device 104 and the MFP 100 perform GO Negotiation processing. A channel to be used in the direct wireless communication may be determined in the GO Negotiation. In the GO Negotiation processing, the portable terminal device 104 and the MFP 100 determine their roles as a P2P group owner (GO) and a P2P client by transmitting or receiving GO Negotiation Request/Response frames including an intent value indicating the strength of their intent to become the GO. Alternatively, the MFP 100 may be booted always as a master station (GO) (autonomous group owner) in the WFD mode. In this case, there is no need to perform the GO Negotiation processing for determining the roles. A configuration is also possible in which the GO Negotiation processing is performed but the MFP 100 always operates as the GO by setting the intent value of its own to the maximum value of 15. Also, in this case, the MFP 100 determines, as the master station, a frequency band and a frequency channel to be used in the direct wireless communication. Therefore, the MFP 100 can select a frequency band to be used from the 2.4 GHz band and the 5 GHz band, and a frequency channel to be used in the selected frequency band.

In step S604, the portable terminal device 104 and the MFP 100 exchange communication parameters through Wi-Fi Protected Setup (WPS) processing. The communication parameters may include parameters to be used in wireless communication, such as a service set identifier (SSID), an encryption method, an encryption key, an authentication method, AKM, BSSID, and MAC Address. AKM is an abbreviation for Authentication and Key Management. AKM indicates an authentication protocol and a key exchange algorithm used for wireless communication. For example, if AKM is “SAE”, the communication parameters may include a password for connecting to an AP or GO supporting Wi-Fi Protected Access (WPA) 3. If AKM is “psk”, the communication parameters may include a pre-shared key (PSK)/passphrase for connecting to an AP or GO supporting WPA2. If AKM is “1X”, the communication parameters may include an ID, a password, a public key, and the like for connecting to an AP supporting WPA-Enterprise. The password and PSK/passphrase are encryption keys used when authentication and key exchange are performed based on WPA and IEEE 802.11. The WPS processing in step S604 is a communication parameter exchange sequence of WFD R1. A channel to be used for communication in the processing in step S604 and the following steps may be changed from the channel used in steps S601 to 603.

When it is determined that the MFP 100 operates as the GO, the MFP 100 starts to transmit a Beacon frame in step S605. The Beacon frame may include communication parameters for communicating with the MFP 100. Also, the Beacon frame may include an Information Element, Attribute, etc., specified in the WFD standard. Accordingly, communication devices other than the portable terminal device 104 can detect the presence of the MFP 100 and can be directly connected to the MFP 100 for wireless communication. For example, another communication device can detect the presence of the MFP 100 by receiving the Beacon frame including information specified in the WFD standard.

In step S606, the portable terminal device 104 transmits a Probe Request frame to execute a connection procedure with the MFP 100. Upon receiving the Probe Request frame, the MFP 100 transmits a Probe Response frame in step S607.

In step S608, the portable terminal device 104 transmits an Authentication frame. Upon receiving the Authentication frame, the MFP 100 transmits an Authentication frame in step S609.

Upon receiving the Authentication frame, the portable terminal device 104 transmits an Association Request frame in step S610. Upon receiving the Association Request frame, the MFP 100 transmits an Association Response frame in step S611.

In step S612, the portable terminal device 104 and the MFP 100 execute 4Way Handshake. By executing the connection procedure described above, a connection is established between the portable terminal device 104 and the MFP 100.

The portable terminal device 104 and the MFP 100 may transmit or receive Provision Discovery Request/Response frames, though not shown in the above sequence. The portable terminal device 104 and the MFP 100 may be reversed in the above processing.

### Connection Processing of New WFD Standard

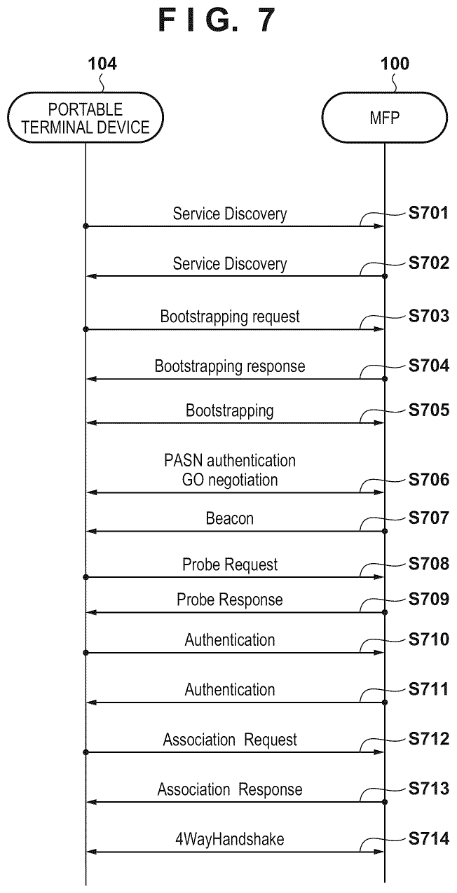

FIG. 7 is a sequence diagram of processing for connecting the portable terminal device 104 and the MFP 100 in accordance with the WFD standard. The sequence shown here is a processing sequence of WFD R2. Processing executed by the devices in this sequence is realized by the CPU included in each of the devices loading various programs stored in a memory such as the ROM included in the device into the RAM and executing the programs.

The processing in this sequence starts, for example, in response to an instruction to start WFD being received from the user by the portable terminal device 104 and the MFP 100. Second search processing is performed in a search sequence of WFD R2. The following describes an example search procedure in the second search processing. In this search procedure, each of the portable terminal device 104 and the MFP 100 executes processing based on whether it is a communication device that provides a service or a communication device that requests the service, and detects the other communication device. A communication device that provides a service may be called a Publisher, a Listener, an Advertiser, or the like. A communication device that requests a service may be called a Subscriber, a Searcher, a Seeker, or the like. For example, a communication device that requests a service may transmit a frame for detecting other communication devices. Also, a communication device that provides a service may receive and respond to a frame transmitted by another communication device. The roles assigned to the communication devices may be determined by an upper layer (a service layer or the like). FIG. 7 shows an example in which the portable terminal device 104 operates as a communication device that requests a service and the MFP 100 operates as a communication device that provides the service. For example, the portable terminal device 104 intermittently performs a detecting operation and transmits a frame for detecting other communication devices. In the second search processing, the mechanism of the Wi-Fi Aware standard set by the Wi-Fi Alliance may be used, for example. That is, frames defined in the Wi-Fi Aware standard may be used as frames communicated in the second search processing. Not only the Wi-Fi Aware standard but also other service search protocols and methods may be used in the second search processing.

In step S701, the portable terminal device 104 transmits a Service Discovery frame to search for a communication device supporting WFD. Here, it is assumed that the Service Discovery frame is transmitted in 6ch of the 2.4 GHz band. The Service Discovery frame is transmitted to search for a partner device that is the target of the search. Here, the communication device performing the search is the portable terminal device 104 and the partner device as the target of the search is the MFP 100. The Service Discovery frame has a WFD attribute, specifying that the target of the search is a communication device supporting WFD.

Upon receiving the Service Discovery frame, the MFP 100 transmits a Service Discovery frame in step S702. The Service Discovery frame transmitted here may be called “SDF Follow up”. The portable terminal device 104 receives the Service Discovery frame and thus detects the MFP 100 as the communication partner of WFD. The second search processing described above is the search sequence of WFD R2. Since different methods are used in the first search processing of WFD R1 and the second search processing of WFD R2, it is not possible to search for a communication device that only supports WFD R1 using the method of WFD R2. Conversely, it is not possible to search for a communication device that only supports WFD R2 using the method of WFD R1.

In step S703, the portable terminal device 104 transmits a request using a Bootstrapping Request frame. This request is a request concerning an exchange method for exchanging communication parameters. Using this frame, the portable terminal device 104 can notify the MFP 100 of an exchange method that can be executed by the portable terminal device 104 among methods for exchanging communication parameters by, for example, pressing a button or using a PIN code, a passphrase, a QR code (registered trademark), an NFC tag, etc. For example, if the portable terminal device 104 can execute an exchange method that uses a QR code, the portable terminal device 104 may indicate at least either the capability to display a QR code or the capability to read a QR code. If the portable terminal device 104 can execute an exchange method that uses a passphrase, the portable terminal device 104 may indicate whether it is possible to use a character string and/or a numerical value. If the portable terminal device 104 can execute the exchange method that uses a passphrase, the portable terminal device 104 may indicate at least either the capability to display a passphrase or the capability to accept input of a passphrase. The portable terminal device 104 may also indicate whether or not it is possible to use a trigger to exchange communication parameters in response to a button being pressed. Information that may be given by the portable terminal device 104 is not limited to those described above.

In step S704, the MFP 100 transmits a response to the portable terminal device 104 with use of a Bootstrapping Response frame as a response to the request using the Bootstrapping Request frame. For example, the MFP 100 may select an exchange method that can be executed by the MFP 100 from among the exchange methods included in the request from the portable terminal device 104 and make a response including information from which the selected exchange method can be identified. If the MFP 100 cannot execute any of the exchange methods included in the request, the MFP 100 may make a response indicating that no method can be executed.

In step S705, Bootstrapping processing is performed with use of an exchange method for exchanging communication parameters determined by the communication devices, to exchange communication parameters. For example, the MFP 100 displays a QR code and the portable terminal device 104 reads the QR code to exchange communication parameters. The Bootstrapping processing in step S705 is a communication parameter exchange sequence of WFD R2.

In step S706, mutual authentication may be performed using PASN authentication. PASN is an abbreviation for Preassociation Security Negotiation. Communication parameters for using the PASN may include public keys of the communication devices, for example. The communication parameters for using the PASN may be exchanged using a method that is not specified in the WFD standard, such as Bluetooth. As another exchange method, a temporary network including an AP may be formed and the communication devices may obtain the communication parameters by accessing the network. In the PASN, the portable terminal device 104 and the MFP 100 may perform the GO Negotiation processing. A channel to be used in the direct wireless communication may be determined in the GO Negotiation. In the GO Negotiation processing, the roles as a P2P group owner (GO) and a P2P client are determined. Alternatively, the MFP 100 may be booted always as a master station (autonomous group owner) in the WFD mode. In this case, there is no need to perform the GO Negotiation processing for determining the roles. A configuration is also possible in which the GO Negotiation processing is performed but the MFP 100 always operates as the GO by setting the intent value of its own to the maximum value of 15. Also, in this case, the MFP 100 determines, as the master station, a frequency band and a frequency channel to be used in the direct wireless communication. Therefore, the MFP 100 can select a frequency band to be used from the 2.4 GHz band, the 5 GHz band, and the 6 GHz band, and a frequency channel to be used in the selected frequency band. Frequency bands that can be used for direct wireless communication using WFD R1 are the 2.4 GHz band and the 5 GHz band, but in WFD R2, the 6 GHz band can also be used as a frequency band for direct wireless communication in addition to the 2.4 GHz band and the 5 GHz band. Unlike WFD R1, in WFD R2, the roles are determined after the communication parameters are exchanged. A channel to be used for communication in processing in step S707 and the following steps may be changed from the channel used in steps S701 to 706.

When it is determined that the MFP 100 operates as the GO, the MFP 100 starts to transmit a Beacon frame in step S707. The Beacon frame may include communication parameters for communicating with the MFP 100. Also, the Beacon frame may include an Information Element, Attribute, etc., specified in the WFD standard. Accordingly, communication devices other than the portable terminal device 104 can detect the presence of the MFP 100 and can be connected to the MFP 100. For example, another communication device can detect the presence of the MFP 100 by receiving the Beacon frame including information specified in the WFD standard.

In step S708, the portable terminal device 104 transmits a Probe Request frame to execute a connection procedure with the MFP 100. Upon receiving the Probe Request frame, the MFP 100 transmits a Probe Response frame in step S709.

In step S710, the portable terminal device 104 transmits an Authentication frame. Upon receiving the Authentication frame, the MFP 100 transmits an Authentication frame in step S711.

Upon receiving the Authentication frame, the portable terminal device 104 transmits an Association Request frame in step S712. Upon receiving the Association Request frame, the MFP 100 transmits an Association Response frame in step S713.

In step S714, the portable terminal device 104 and the MFP 100 execute 4Way Handshake. By executing the connection procedure described above, a connection is established between the portable terminal device 104 and the MFP 100.

The portable terminal device 104 and the MFP 100 may be reversed in the above processing. In addition, it is assumed that whether the communication devices support WFD R1 or WFD R2 can be indicated by P2P IE.

### Security Settings of MFP

The following describes security settings of the MFP 100 according to the present embodiment and security management corresponding to the security settings. In this specification, the term “wireless direct connection” refers to a connection that uses wireless communication in accordance with the WFD standard including WFD R1 and WFD R2. Also, communication performed using the wireless direct connection may be referred to as “wireless direct communication”. In WFD R1, WPA and WPA2 are supported as the security protocols for wireless LANs, but WPA3 is not always supported. On the other hand, in WFD R2, WPA2 and WPA3 are supported as the security protocols for wireless LANs. WPA3 is a security protocol that uses strong ciphers and keys with high security, compared with WPA and WPA2. For example, in WPA3-personal, different pairwise master keys (PMKs: master keys) are generated for respective connections from a pre-shared key (PSK). Accordingly, even if a password is leaked or decoded, it is possible to prevent decoding of data by establishing a connection again. Note that security protocols include, for example, specifications of an authentication method and an encryption method (encryption algorithm), and are sometimes called encryption methods.

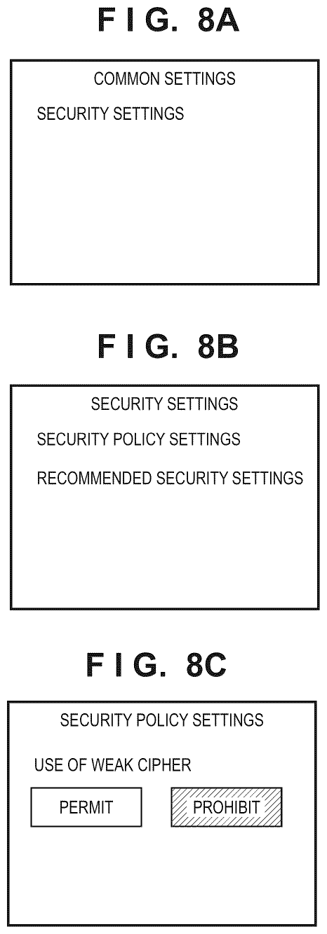

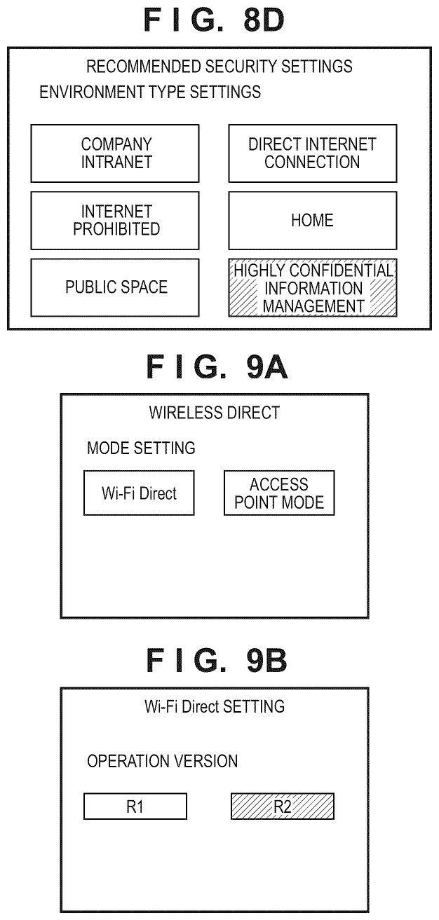

FIGS. 8A to 8D schematically show examples of security setting screens displayed on a display (touch panel display) included in the operation display unit 220 of the MFP 100. FIG. 8A shows an example of a menu screen of common settings, which is displayed when “common settings” is selected on the communication setting screen shown in FIG. 3C. A menu item “security settings” is displayed on the menu screen of common settings.

FIG. 8B shows an example of a menu screen of security settings, which is displayed when “security settings” is selected on the common setting screen shown in FIG. 8A. On the menu screen of security settings, “security policy settings” and “recommended security settings” are displayed as menu items (options).

FIG. 8C shows an example of a security policy setting screen, which is displayed when “security policy settings” is selected on the security setting screen shown in FIG. 8B. A security policy is a basic policy regarding information security determined for each office, which is applied to communication devices such as personal computers (PCs), server devices, multifunction peripherals, printers, etc., connected to a network in the office, for example. The server devices include server devices such as a file server and an authentication server. A security manager provides, for example, a security policy “prohibit the use of a weak cipher” as one item of security policy settings to strengthen the security, and sets the security policy in the communication devices. This security policy prohibits the use of vulnerable ciphers to satisfy safety standards set by NIST SP800-57. A weak cipher is, in other words, a cipher with a low security level. Specifically, a cipher with a low security level is, for example, a cipher that uses an encryption key having a key length equal to or less than 1024 bits for communication. If the security policy “prohibit the use of a weak cipher” is applied to a communication device, the communication device cannot communicate using an encryption key or certificate that does not comply with the security policy. In the present embodiment, security policy settings are applied to communication performed based on Transport Layer Security (TLS), IPSec, Kerberos, S/MIME, SNMPv3, and the like. That is, when the security policy “prohibit the use of a weak cipher” is set, the use of an RSA/DSA/DH encryption key having a key length equal to or less than 1024 bits for a public-key cipher is prohibited in at least one of the above-described communication. The content of the prohibited communication is not limited to that described above. For example, it is also possible to prohibit communication in which an encryption method with a low security level is used. Specifically, for example, if the security policy “prohibit the use of a weak cipher” is set, communication in which an encryption method such as RC2, RC4, or DES is used as a common key cipher may be prohibited. In this case, for example, even if the security policy “prohibit the use of a weak cipher” is set, communication in which an encryption method such as 3DES or AES is used may be permitted.

On the security policy setting screen, the user can set whether to “permit” or “prohibit” the use of a weak cipher. Regarding WFD connection settings, the case where the use of a weak cipher is “prohibited” is handled as a case where the security setting is “high”, i.e., a high-level security setting is set. The wording “high level” means that the level of the security setting is high compared with a security setting that permits the use of a weak cipher, and may also read “specific level”. When the high-level security setting is set, a security policy is applied to prohibit the use of WFD R1, in which it may not be possible to establish a connection using WPA3, which is a security protocol corresponding to the high level, and to permit only the use of WFD R2, in which a connection can be established using WPA3. That is, if the security policy “prohibit the use of a weak cipher” is applied to a communication terminal, the communication terminal applies control to restrict the use of a weak cipher in both TLS communication and WFD communication.

As described above, if a security policy including the prohibition of the use of a weak cipher is set, control is performed for WFD to prevent the use of a wireless connection established using a connection method that does not support a security protocol having a security level corresponding to the high-level security setting. In this example, for example, a security protocol that uses strong ciphers satisfying criteria recommended by NIST SP800-57 is a security protocol having a predetermined security level corresponding to the high-level security setting or a higher security level. Also, a connection method (e.g., WFD R2) in which this protocol (e.g., WPA3) can be used is the connection method corresponding to the high-level security setting. Specifically, connection methods other than WPA3 may be excluded from connection method options to be selected by the user in order to perform control for restricting the use of a security protocol that does not correspond to the high-level security setting. Although NIST SP800-57 is referred to here as the criteria for determining whether the security level is high or low, other standards or the like may also be used as the criteria.

FIG. 8D shows an example of a recommended security setting screen, which is displayed when “recommended security settings” is selected in FIG. 8B.

On the recommended security setting screen, the type of the environment in which the MFP 100 is installed is selected from “company intranet”, “direct Internet connection”, “Internet prohibited”, “home”, “public space”, and “highly confidential information management” to collectively set settings corresponding to the environment type. Table 1 shows examples of the environment types and values of setting items. As for setting items for which “optional” is shown in Table 1, settings such as on or off determined according to the selected environment type are not applied, and current setting values are not changed. In the present embodiment, for example, the settings executed via the recommended security setting screen are applied to communication based on TLS, IPSec, Kerberos, S/MIME, SNMPv3, or the like.

TABLE 1

| | | | | | | Highly |
|---|---|---|---|---|---|---|
| | | Direct | | | | confidential |
| | Company | Internet | Internet | | Public | information |
| Setting items | intranet | connection | prohibited | Home | space | management |
| TLS setting | On | On | Optional | On | On | On |
| WINS setting | Off | Off | Optional | Off | Off | Off |
| Prohibition of | Prohibited | Optional | Optional | Prohibited | Prohibited | Prohibited |
| storing | | | | | | |
| authentication | | | | | | |
| password of | | | | | | |
| external server | | | | | | |
| in cache | | | | | | |
| Minimum | 8 letters | 8 letters | Optional | 8 letters | 8 letters | 8 letters |
| number of letters | | | | | | |
| included in | | | | | | |
| password | | | | | | |
| Complete | Optional | Optional | Optional | On | On | On |
| deletion of | | | | | | |
| hard disk | | | | | | |
| SMB sever | Optional | Off | Optional | Off | Off | Off |
| setting | | | | | | |
| Use of external | Off | Off | Off | Off | Off | Off |
| USB storage | | | | | | |
| Default policy of | Optional | Optional | Optional | Refuse | Refuse | Optional |
| IP address filter | | | | | | |
| Exceptional | Optional | Optional | Optional | Subnet | Subnet | Optional |
| address for IP | | | | address of | address of | |
| address filter | | | | device | device | |
| Default policy of | Optional | Optional | Optional | Refuse | Refuse | Optional |
| IP address filter | | | | | | |
| Exceptional | Optional | Optional | Optional | Subnet | Subnet | Optional |
| address for IP | | | | address of | address of | |
| address filter | | | | device | device | |

“Company intranet” is a setting for a typical office environment where a large number of people come together and an Internet connection is also established to use some cloud services. The number of information devices to be connected is the largest when compared with the other use environments. In such an environment, a controlled firewall is commonly provided at the boundary with an external network, and entry is limited only to employees. Security measures taken on the use environment side and security measures taken by each terminal are used in a well-balanced manner.

“Direct Internet connection” is a setting for an environment in which an Internet connection is established to use cloud services. A connected information device, which is the MFP 100 in this example, is connected via the Internet to a server that provides cloud services, and therefore encryption of a communication path is required.

“Internet prohibited” is a setting for an environment in which a connection to the Internet is shut off in a network topology because an old protocol is used for some reason, for example, and the MFP 100 is used in an isolated network. The number of information devices to be connected is relatively small. By taking strong security measures on the use environment side, it is possible to relax the level of security measures to be taken on the terminal side.

“Home” is a setting for an environment in which a small LAN used at home is used as it is for work at home, assuming a home network used in remote working. The number of information devices to be connected is the smallest. Security measures need to be taken on the terminal side in a well-balanced manner on the premise that security measures taken on the use environment side are not so reliable.

“Public space” is a setting for an open space where an unspecified number of people come in and out and share a network. Airport lounges and co-working spaces available for guests correspond to such open spaces, which are used under non-stringent access restrictions. The number of information devices to be connected is relatively large. It is necessary to take security measures on the terminal side even at the expense of functionality to some extent, basically without trusting security measures taken on the use environment side.

“Highly confidential information management” is a setting for a typical office environment for which there is a restriction on entry. There is also a restriction on information devices to be connected. That is, the environment type “highly confidential information management” corresponds to an environment in which access to the MFP 100 is restricted. In such an environment, a controlled firewall is commonly provided at the boundary with an external network.

Regarding WFD connection settings, “direct Internet connection” and “highly confidential information management”, for which there are restrictions on information devices to be connected, are handled as “high” security settings. If a high-level security setting is set, that is, if either of the two environment types “direct Internet connection” and “highly confidential information management” is set, the use of WFD R1 is prohibited as in the case where “prohibit the use of a weak cipher” is set. In this example, the two environment type settings are regarded as high-level security settings, but it is also possible to regard either one of them as a high-level security setting. As described above, the security policy that prohibits the use of a weak cipher is a high-level security setting as well. If either the security policy or environment type setting described above corresponds to the high level, it is possible to regard the security setting as being set to the high level.

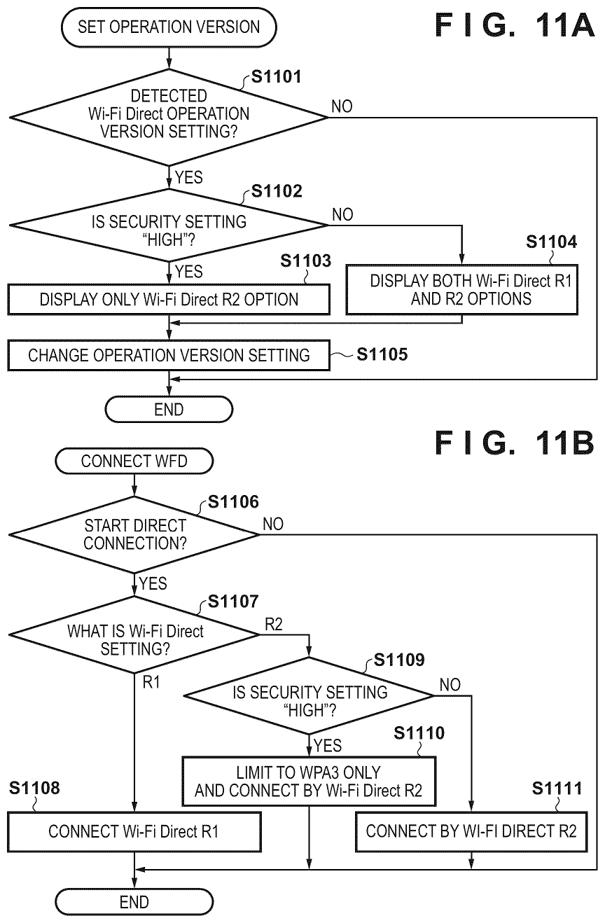

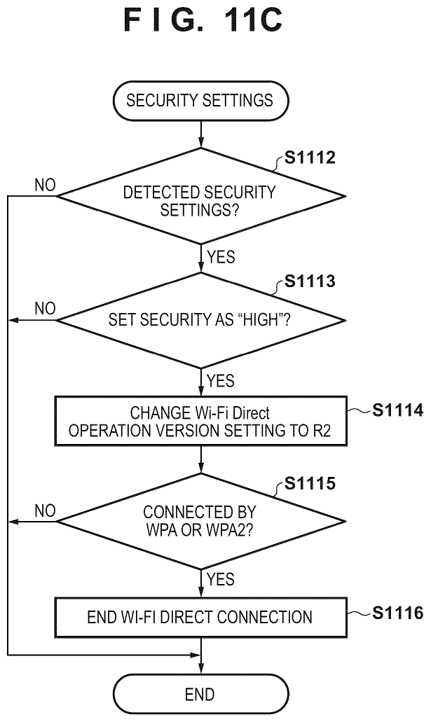

In WFD R1, support for WPA and WPA2 is required, but support for WPA3 is optional. In WFD R2, support for WPA2 and WPA3 is required, but WPA is not supported. Accordingly, when the security setting is “high”, it is possible to limit WFD connections to connections using WPA3 by prohibiting the use of WFD R1 and suppressing the establishment of a connection using WPA2 in the connection processing of WFD R2. On the other hand, if it is determined that the security setting is not “high”, it is possible to use WFD R1 as the connection method. The case where the security setting is not “high” is the case where the use of a weak cipher is “permitted” according to a security policy setting and the environment type setting is neither “direct Internet connection” nor “highly confidential information management”. In this case, the security protocol is not limited to WPA3 even if WFD R2 is used, and accordingly, a connection can be established using WPA or WPA2. Among the environment type settings, settings that are not high-level security settings (i.e., low-level security settings) are environment type settings that are neither “direct Internet connection” nor “highly confidential information management”. Setting values of the security policy setting selected in FIG. 8C and the environment type setting selected on the screen shown in FIG. 8D are stored in the non-volatile memory 215, for example, and are referred to by the CPU 212 in the processing shown in FIGS. 11A to 11C, which will be described later.

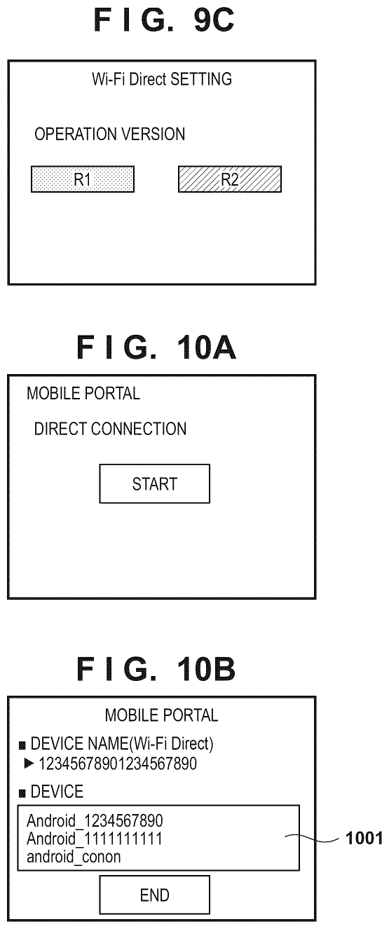

FIGS. 9A to 9C schematically show an example of a wireless direct setting screen displayed on the display (touch panel display) included in the operation display unit 220 of the MFP 100. FIG. 9A shows an example of a menu screen that is displayed when “wireless direct” is selected on the communication setting screen shown in FIG. 3C. The wireless direct mode setting screen allows selection of the wireless direct mode from “Wi-Fi Direct” in accordance with the Wi-Fi Direct standard and “access point mode”.

FIG. 9B shows an example of operation version settings that are displayed when “Wi-Fi Direct” is selected on the wireless direct setting screen shown in FIG. 9A. The Wi-Fi Direct setting screen allows selection of WFD R1 or WFD R2 as the version or connection method.

FIG. 9C shows an example of operation version settings that are displayed when “Wi-Fi Direct” is selected on the wireless direct setting screen shown in FIG. 9A and a high-level security setting is set, i.e., when the use of WFD R1 is prohibited. A button is grayed out and disabled so that the WFD R1 setting cannot be selected. As described above, cases where a high-level security setting is set include, for example, the case where the use of a weak cipher is prohibited on the security policy setting screen shown in FIG. 8C. Also, the cases include the case where Internet connection or highly confidential information management is set on the environment type setting screen shown in FIG. 8D.

### WFD Connection Procedure

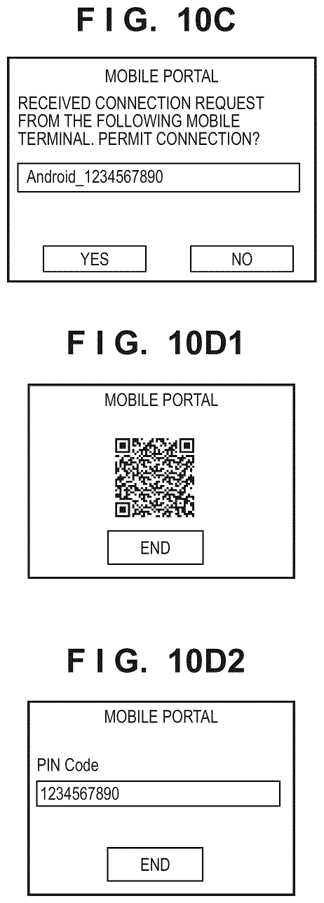

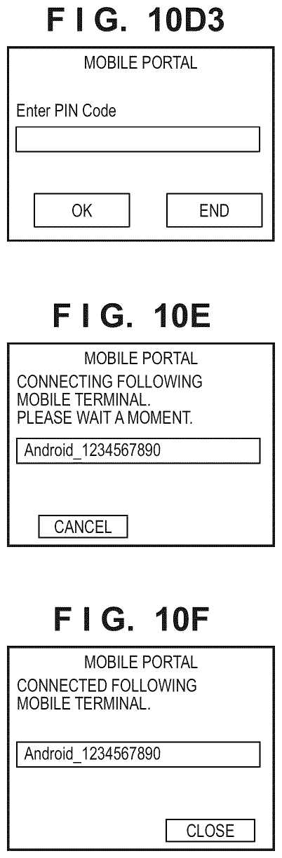

FIGS. 10A to 10F schematically show an example of a mobile portal screen displayed on the display (touch panel display) included in the operation display unit 220 of the MFP 100. FIG. 10A shows an example of the mobile portal screen, which is displayed when a mobile portal function is selected in FIG. 3B. When a start button is pressed, wireless direct connection processing is performed in accordance with a wireless direct mode. In the case of the WFD mode, WFD connection processing of a version corresponding to the operation version setting is performed.

FIG. 10B shows an example of a screen that is displayed when the connection processing is started in the WFD mode. A connection destination can be determined by selecting a portable terminal device to be connected from a device list 1001. When an end button is pressed, the connection processing in the WFD mode ends.

FIG. 10C shows a screen that is displayed when the connection processing is started using WFD R1 and a connection request is received from the portable terminal device 104 in the GO Negotiation processing. If “Yes” is pressed, the connection is permitted and the subsequent processing sequence is executed. If “No” is pressed, the WFD connection processing ends.

FIGS. 10D1 to 10D3 show examples of screens for exchanging communication parameters, which are displayed when the connection processing is started using WFD R2. The screens are determined through communication with the portable terminal device 104 using a Bootstrapping Request and a Bootstrapping Response. When the device is selected from the device list 1001 shown in FIG. 10B or a Bootstrapping Request is received from the portable terminal device 104 and a method for exchanging communication parameters is determined with the portable terminal device 104, any of the screens for exchanging communication parameters is displayed. Any of the screens shown in FIGS. 10D1 to 10D3 is displayed in accordance with the determined method for exchanging communication parameters. FIG. 10D1 shows a screen on which the MFP 100 displays a QR code (registered trademark), FIG. 10D2 shows a screen on which the MFP displays a PIN code, and FIG. 10D3 shows a screen for inputting a PIN code to the MFP. In the cases shown in FIGS. 10D1 and 10D2, the user inputs the QR code (registered trademark) or the PIN code displayed on the screens to the portable terminal device 104. In the case shown in FIG. 10D3, the user inputs a PIN to the MFP 100.

FIG. 10E shows an example of a screen that is displayed when authentication processing in the WFD connection processing is started. In WFD R1, this screen is displayed when a portable terminal device to be connected is selected from the device list shown in FIG. 10B or the user presses “Yes” in FIG. 10C. In WFD R2, this screen is displayed after the exchange of communication parameters is complete in FIGS. 10D1 to 10D3.

FIG. 10F shows an example of a screen that is displayed when the WFD connection processing is complete.

### Wireless Direct Setting Processing and Connection Processing

FIG. 11A is a flowchart showing processing in which the MFP 100 sets an operation version of WFD. Processing performed by the MFP 100, which is a communication device, in this flowchart is realized by the CPU 212 by loading various programs stored in a memory such as the ROM 213 into the RAM 214 and executing the programs. When “wireless direct” is selected on the screen shown in FIG. 3C and the mode setting screen shown in FIG. 9A is displayed, the processing shown in FIG. 11A starts.

In step S1101, the CPU 212 detects selection of Wi-Fi Direct on the mode setting screen. Upon detecting selection of an operation version, the CPU 212 proceeds to step S1102, otherwise the CPU 212 ends the processing. Alternatively, step S1101 may be repeated to wait for selection of an operation version.

In step S1102, the CPU 212 determines whether or not a high-level security setting has been set. For example, if the use of a weak cipher is prohibited by the security policy setting or if the environment type set by the recommended security setting is “direct Internet connection” or “highly confidential information management”, it is determined that a high-level security setting has been set. On the other hand, if the use of a weak cipher is permitted by the security policy setting or if the environment type set by the recommended security setting is other than “direct Internet connection” and “highly confidential information management”, it is determined that a high-level security setting has not been set. As described above, the security policy setting and the recommended security setting are executed on the screens shown in FIGS. 8C and 8D. The CPU 212 stores information indicating the content of the settings executed on the screens shown in FIGS. 8C and 8D. This determination is made based on the content of the stored information. Upon determining that a high-level security setting has been set, the CPU 212 proceeds to step S1103, otherwise, the CPU 212 proceeds to step S1104.

In step S1103, the CPU 212 displays a Wi-Fi Direct operation version setting screen that enables the user to set WFD R2 only. For example, the CPU 212 displays a screen that prevents selection of the WFD R1 selection button (FIG. 9C). In FIG. 9C, this button is grayed out so as not to be selected, but it is also possible to hide the button, for example. In step S1105, the CPU 212 sets a selected operation version. Since only WFD R2 can be selected in step S1103, WFD R2 is set as the operation version in response to the selection of WFD R2. Alternatively, WFD R2 may be set as the operation version without being selected by the user.

In step S1104, the CPU 212 displays a Wi-Fi Direct operation version setting screen that enables the user to select WFD R1 and WFD R2 (FIG. 9B). In step S1105, the CPU 212 sets either WFD R1 or WFD R2 selected by the user as the operation version. The operation version set in step S1105 is stored in the non-volatile memory 215 or the like. Thus, the processing for selecting the operation version ends.

As described above, when a high-level security setting is set, a user interface is displayed such that it is possible to select only a connection method that uses a strong security protocol corresponding to the high-level security setting. This excludes a connection method in which security protocols with a low security level may be used, from the options to be selected. Therefore, when the high-level security setting is set, it is possible to prevent a situation in which only the security protocols with a low security level, such as WPA and WPA2, can be used.

FIG. 11B is a flowchart showing processing in which the MFP 100 starts to establish a WFD connection. Processing performed by the MFP 100, which is a communication device, in this flowchart is realized by the CPU 212 by loading various programs stored in a memory such as the ROM 213 into the RAM 214 and executing the programs.

In step S1106, the CPU 212 determines whether or not the CPU 212 has received an instruction to start Wi-Fi Direct connection from the user. For example, when the direct connection start button is pressed on the mobile portal screen (FIG. 10A) in the state where the wireless direct mode has been set to Wi-Fi Direct on the wireless direct setting screen (9A), the CPU 212 determines that a connection start instruction has been received. Upon receiving the connection start instruction, the CPU 212 proceeds to step S1107, otherwise ends the processing. Alternatively, step S1106 may be repeated to wait for the connection start instruction.

In step S1107, the CPU 212 checks the Wi-Fi Direct operation version setting, and if WFD R1 has been set, the CPU 212 proceeds to step S1108, and if WFD R2 has been set, the CPU 212 proceeds to step S1109. It is possible to check the operation version by referring to the operation version set in the procedure shown in FIG. 11A and stored in step S1105.

In step S1108, the CPU 212 performs connection processing with the portable terminal device 104 by using WFD R1. This connection processing is as shown in FIG. 6. A connection to an external device such as the portable terminal device 104 is established using, for example, the wireless unit 226 as a communication unit. The MFP is connected to a device that has been selected from the device list 1001 shown in FIG. 10B. When a connection request is received in step S1108, the screen shown in FIG. 10C is displayed, and when the connection is permitted, the connection processing is continued and the screen shown in FIG. 10E is displayed. When the connection is complete or when the connection processing is canceled, the processing ends. When the connection is complete, the screen shown in FIG. 10F is displayed.

In step S1109, the CPU 212 determines whether or not a high-level security setting has been set. Upon determining that the set security setting is a high-level security setting, the CPU 212 proceeds to step S1110, otherwise, the CPU 212 proceeds to step S1111. In this step, whether or not a high-level security setting has been set may be determined similarly to step S1102.

In step S1110, the CPU 212 performs connection processing with the portable terminal device 104 using WFD R2 by limiting the security protocol to WPA3. This connection processing is as shown in FIG. 7. It is possible to limit the security protocol to WPA3 by excluding WPA and WPA2 from security protocols supported by the MFP 100 at the time when parameters are exchanged in the connection processing using WFD R2. When the connection is complete or when the connection processing is canceled, the processing ends. In step S1110, either of the screens shown in FIGS. 10D1 and 10D2 is displayed, the screen switches to the screen shown in FIG. 10E when the user responds to the displayed screen, and the screen shown in FIG. 10F is displayed when the connection is complete.

In step S1111, the CPU 212 performs connection processing with the portable terminal device 104 using WFD R2. When the connection is complete or when the connection processing is canceled, the processing shown in FIG. 11B ends. Thus, the WFD connection processing ends.

In this way, a connection can be established using a cipher whose strength corresponds to the level of the security setting.

FIG. 11C is a flowchart showing processing in which the MFP 100 changes a security setting. Processing executed by the MFP 100, which is a communication device, in this flowchart is realized by the CPU 212 by loading various programs stored in a memory such as the ROM 213 into the RAM 214 and executing the programs.

In step S1112, the CPU 212 determines whether or not “security settings” is selected on the common setting screen shown in FIG. 8A. When it is selected, the CPU 212 proceeds to step S1113, otherwise ends the processing. Alternatively, step S1112 may be repeated to wait for the selection of “security settings”.

In step S1113, the CPU 212 accepts a security setting set by the user, and determines whether or not the set security setting is a high-level security setting. Examples of the security setting include a security policy setting and an environment type setting. If the set security setting is a high-level security setting, the CPU 212 proceeds to step S1114, and if the set security setting is not a high-level security setting, the CPU 212 ends the processing. High-level security settings include at least either the security policy setting that prohibits the use of a weak cipher (FIG. 8C) or the environment type setting (FIG. 8D) corresponding to direct Internet connection or highly confidential information management.

In step S1114, the CPU 212 changes the Wi-Fi Direct operation version setting to R2 and proceeds to step S1115.

In step S1115, the CPU 212 determines whether or not a WFD connection to the portable terminal device 104 has been established using WPA or WPA2. If the connection has been established using WPA or WPA2, the CPU 212 proceeds to step S1116, otherwise ends the processing.

In step S1116, the CPU 212 shuts off the WFD connection and ends the processing. The connection that is shut off, i.e., canceled here is not only a connection using WFD R1. Even a connection using WFD R2 is canceled if WPA2 is used. That is, when a security level higher than a predetermined level (or equal to or higher than the predetermined level) is set, if the communication device has been connected to an external device such as the portable terminal device at a security level lower than the predetermined level, the connection is canceled.

In the above procedure, the Wi-Fi Direct operation version setting has been set to R2 in step S1114, and accordingly, the next WFD connection will be established using R2. If WPA and WPA2, which are security protocols prohibited from being used in the high-level security setting, are used for a wireless direct connection, the connection is canceled. In this manner, even when a high security level is set, a connection with a security level corresponding to the high security level is realized. Although the connection using WPA or WPA2 is shut off as an example, it is also possible to apply other disconnection criteria, i.e., it is also possible to only shut off connections using WPA.

Before proceeding to step S1116, it is also possible to display a screen for notifying the user that the WFD connection will be shut off if the security setting is changed, and asking if the user wants to restore the security setting. In this case, if the user chooses to restore the security setting, the security setting and the Wi-Fi Direct operation version may be restored to their original settings and the processing may be ended. Alternatively, before proceeding to step S1113, if the user has performed an operation to change the security setting to “high”, the operation may be detected and whether or not a WFD connection has been established using WPA or WPA2 may be confirmed. In the case where an operation to change the security setting to “high” has been performed and a WFD connection has been established using WPA or WPA2, the user may be notified that the WFD connection will be shut off if the security setting is changed. For this notification, a screen for confirming whether or not to cancel the change in the security setting may be displayed, and if canceling of the change is selected, the processing may be ended.

As described above, when a high-level security setting is set, it is possible to prevent setting of a connection method that does not correspond to the high-level security setting and in which only a security protocol with a low security level can be used. When establishing a new connection, it is possible to use a connection method in which a security protocol corresponding to the level of the security setting can be used, and to use the security protocol corresponding to the level of the security setting. If a connection has already been established when the high-level security setting is set, the high-level security setting is set, and if the security protocol used for the existing connection does not correspond to the high-level security setting, the connection is shut off (canceled) These operations enable a connection using a security protocol that corresponds to the high-level security setting.

With the configuration and processing procedure shown in the present embodiment, it is possible to set a WFD connection method in accordance with a security setting.

Regarding the above description of the processing during reception of print data, similar processing can be applied during reception of other data different from print data or transmission of other data. For example, similar processing can be applied when a document is scanned by the reading unit 219 and the scanned image (image data) is transmitted to the portable terminal device (104) via an AP.

Note that the various types of control described above as control performed by the CPU 212 may be performed by a single piece of hardware, or multiple pieces of hardware (e.g., processors or circuits) may share the processing to control the entire device.

Also, preferred embodiments have been described in detail, but the techniques of the present disclosure is not limited to these specific embodiments and encompasses various forms within a scope not departing from the gist of the present disclosure. Furthermore, the embodiments described may be combined as appropriate.

Also, a case in which the technology according to the present disclosure is applied to a MFP is described as an example in the above embodiments, but there is no limitation to this example, and the technology is applicable to a wireless device that functions as a STA that can perform processing in accordance with a connection destination change request from an AP. That is to say, the technology according to the present disclosure is applicable to a personal computer, a PDA, a tablet terminal, a mobile phone terminal such as a smartphone, a music player, a game player, an electronic book reader, a smart watch, and various measurement devices (sensor devices) such as a thermometer and a hygrometer. Also, the technology according to the present disclosure is applicable to a digital camera (including a still camera, a video camera, a network camera, and a security camera), a printer, a scanner, and a drone. Also, the technology according to the present disclosure is applicable to a video output device, an audio output device (e.g., a smart speaker), a media streaming player, and a wireless LAN adapter that can be connected to a USB terminal or a LAN cable terminal. The video output device includes a device such as a set top box, obtains (downloads) a moving image or still image on the Internet, which is identified by a URL designated by an electronic device, and outputs the image to a display device connected via a video output terminal such as HDMI (registered trademark). Thus, streaming reproduction or mirroring display (displaying contents displayed on the electronic device also on the display device) on the display device is realized. The video output device also includes a television, media players such as a hard disk recorder, a Blu-Ray recorder, and a DVD recorder, a head mounted display, a projector, a television, a display device (monitor), and a signage device. Also, the technology according to the present disclosure is applicable to so-called smart home appliances capable of establishing a Wi-Fi connection, such as an air conditioner, a refrigerator, a washing machine, a vacuum cleaner, an oven, a microwave oven, a lighting device, a heating device, and an air-cooling device.

In the above description, an embodiment is described in which two settings are regarded as high-level security settings, i.e., a security policy setting that prohibits the use of a weak cipher and a recommended security setting corresponding to an environment type “direct Internet connection” or “highly confidential information management”. However, there is no limitation to this embodiment, and a configuration is also possible in which only either one of the two settings is regarded as the high-level security setting, or a setting other than these two settings is regarded as a high-level security setting.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-208885, filed Nov. 29, 2024 which is hereby incorporated by reference herein in its entirety.

What is claimed is:

1. A communication device capable of communicating with an information processing device, the communication device comprising:
at least one memory storing instructions; and
at least one processor that is in communication with the at least one memory and that, when executing the instructions, cooperates with the at least one memory to execute processing, the processing including:
accepting an operation for applying any of a plurality of settings including a first setting and a second setting to the communication device, as a setting regarding security of the communication device;
executing communication based on Wi-Fi Direct R1 between the information processing device and the communication device;
executing communication based on Wi-Fi Direct R2 between the information processing device and the communication device; and
controlling, based on the first setting being applied to the communication device as the setting regarding security of the communication device, the communication device such that communication based on Wi-Fi Direct R1 is not executable between the information processing device and the communication device.

2. The communication device according to claim 1,
wherein, in a state where the second setting is applied to the communication device as the setting regarding security of the communication device, the communication device is controlled such that communication based on Wi-Fi Direct R1 is executable between the information processing device and the communication device.

3. The communication device according to claim 1,
wherein the communication device is controlled such that communication based on Wi-Fi Direct R2 is executable between the information processing device and the communication device both in a state where the first setting is applied to the communication device as the setting regarding security of the communication device and in a state where the second setting is applied to the communication device as the setting regarding security of the communication device.

4. The communication device according to claim 1,
the processing further including:
accepting a first operation for causing the communication device to execute an operation to execute communication based on Wi-Fi Direct R1 between the information processing device and the communication device; and
accepting a second operation for causing the communication device to execute an operation to execute communication based on Wi-Fi Direct R2 between the information processing device and the communication device,
wherein, in a case where the first setting is applied to the communication device as the setting regarding security of the communication device, the communication device is controlled so as not to accept the first operation, whereby the communication device is controlled such that communication based on Wi-Fi Direct R1 is not executable between the information processing device and the communication device.

5. The communication device according to claim 4,
the processing further including:
displaying a selection screen including at least one of a first option for accepting the first operation and a second option for accepting the second operation,
wherein, in a case where the first setting is applied to the communication device as the setting regarding security of the communication device, control is performed so as not to display the first option on the selection screen, whereby the communication device is controlled so as not to accept the first operation.

6. The communication device according to claim 5,
wherein, in a case where the second setting is applied to the communication device as the setting regarding security of the communication device, control is performed so as to display both the first option and the second option on the selection screen.

7. The communication device according to claim 4,
the processing further including:
displaying, in a case where the first operation is accepted, a screen for selecting the information processing device as a destination of a connection based on Wi-Fi Direct R1; and
displaying, in a case where the second operation is accepted, a screen for selecting the information processing device as a destination of a connection based on Wi-Fi Direct R2.

8. The communication device according to claim 1,
the processing further including:
performing, in a case where the second setting is applied to the communication device as the setting regarding security of the communication device, control so as to use a first security protocol and so as not to use a second security protocol different from the first security protocol when establishing a connection based on Wi-Fi Direct R2.

9. The communication device according to claim 8,
wherein the first security protocol is WPA3, and the second security protocol is WPA or WPA2.

10. The communication device according to claim 1,
the processing further including:
in a state where a first operation setting has been set in the communication device to cause the communication device to execute an operation for executing communication based on Wi-Fi Direct R1 between the information processing device and the communication device, if the first setting is applied to the communication device as the setting regarding security of the communication device, changing the first operation setting to a second operation setting to cause the communication device to execute an operation for executing communication based on Wi-Fi Direct R2 between the information processing device and the communication device.

11. The communication device according to claim 1,
the processing further including:
in a state where a connection based on Wi-Fi Direct has been established between the information processing device and the communication device using a second security protocol different from a first security protocol, if the first setting is applied to the communication device as the setting regarding security of the communication device, shutting off the connection based on Wi-Fi Direct between the information processing device and the communication device.

12. The communication device according to claim 11,
wherein the first security protocol is WPA3, and the second security protocol is WPA or WPA2.

13. The communication device according to claim 1,
wherein the setting regarding security of the communication device is a setting indicating whether or not to prohibit use of a cipher with a low security level,
the first setting prohibits use of the cipher with a low security level, and
the second setting permits use of the cipher with a low security level.

14. The communication device according to claim 13,
wherein the cipher with a low security level includes a cipher that uses an encryption key having a key length of 1024 bits or less for communication.

15. The communication device according to claim 14,
wherein, in a case where the first setting is applied to the communication device as the setting regarding security of the communication device, control is performed to prohibit use of the cipher with a low security level in communication based on Wi-Fi Direct, and control is further performed to prohibit use of the cipher with a low security level in at least one of communication based on Transport Layer Security (TLS), communication based on IPSec, communication based on Kerberos, communication based on S/MIME, and communication based on SNMPv3.

16. The communication device according to claim 1,
wherein the setting regarding security of the communication device is a setting indicating a type of an environment in which the communication device is installed,
the first setting includes at least one of a setting indicating an environment in which an Internet connection is established to use a cloud service and a setting indicating an environment in which there is a restriction on entry, and
the second setting includes at least one of a setting indicating that the communication device is installed in a public space, a setting indicating that the communication device is installed in a home, and a setting indicating that the communication device is installed in an office.

17. The communication device according to claim 1,
wherein the setting regarding security of the communication device includes both a setting indicating whether or not to prohibit use of a cipher with a low security level and a setting indicating a type of an environment in which the communication device is installed.

18. The communication device according to claim 1,
the processing further including executing printing.

19. A method for controlling a communication device capable of communicating with an information processing device, the method comprising:
accepting an operation for applying any of a plurality of settings including a first setting and a second setting to the communication device, as a setting regarding security of the communication device;
executing communication based on Wi-Fi Direct R1 between the information processing device and the communication device;
executing communication based on Wi-Fi Direct R2 between the information processing device and the communication device; and
controlling, based on the first setting being applied to the communication device as the setting regarding security of the communication device, the communication device such that communication based on Wi-Fi Direct R1 is not executable between the information processing device and the communication device.

20. A non-transitory computer-readable storage medium storing therein a program that, when loaded into a computer included in a communication device capable of communicating with an information processing device and executed by the computer, causes the computer to execute processing including:
accepting an operation for applying any of a plurality of settings including a first setting and a second setting to the communication device, as a setting regarding security of the communication device;
executing communication based on Wi-Fi Direct R1 between the information processing device and the communication device;
executing communication based on Wi-Fi Direct R2 between the information processing device and the communication device; and
controlling, based on the first setting being applied to the communication device as the setting regarding security of the communication device, the communication device such that communication based on Wi-Fi Direct R1 is not executable between the information processing device and the communication device.
